(19) United States
(12) Patent Application Publication
(10) Pub. No.: US 2014/0079948 A1
(43) Pub. Date: Mar. 20, 2014

(54) DECORATIVE FILM FOR POLYOLEFIN MOLDED BODY

(71) Applicant: THE YOKOHAMA RUBBER CO., LTD., TOKYO (JP)

(72) Inventor: Shigeru ISHIDA, HIRATSUKA CITY, KANAGAWA (JP)

(73) Assignee: THE YOKOHAMA RUBBER CO., LTD., TOKYO (JP)

(21) Appl. No.: 14/030,086

(22) Filed: Sep. 18, 2013

(30) Foreign Application Priority Data
Sep. 20, 2012 (JP) 2012-207280

(51) Int. Cl. C09J 7/02

(52) U.S. Cl. CPC C09J 7/0264
USPC 428/354; 428/355 BL; 428/483

(57) ABSTRACT

A decorative film for a polyolefin molded body, the film having a PET base material, wherein the decorative film demonstrates superior adhesive properties with respect to polyolefin molded bodies, as well as a laminate in which the decorative film is laminated upon a polyolefin molded body. A decorative film for a polyolefin molded body, the film comprising a PET base material (A) and an adhesive layer (B) containing a maleic acid-modified polypropylene.

### BACKGROUND OF THE INVENTION

The present technology relates to a decorative film for a polyolefin molded body and a laminate in which the decorative film is laminated to a polyolefin molded body.

Resin molded bodies are widely used in industrial material fields such as household electronics, construction members, and automobiles for their superior mechanical properties, heat resistance, chemical resistance, and moisture resistance. Examples of resins used in resin molded bodies include polyvinyl chloride, nylon, polyester, polycarbonate, ABS resin, and polyolefins, of which polyolefins (such as polypropylene (PP)) are preferable in terms of cost and recyclability.

In recent years, there has been a demand to decorate the surfaces of resin molded bodies with wood, fabric, or metallic effects in order to improve the design properties of these industrial materials. A technology used for this purpose is a method of sandwiching a decorative film involving a decorative layer (metal layer, ink layer and the like) formed on a substrate between molding dies, injecting molten resin into the dies, and cooling the resin to obtain a resin molded body while simultaneously bonding the decorative film to the surface of the molded body, thereby decorating the resin molded body (hereafter referred to as the “simultaneous molding/decorating method”).

Japanese Patent No. 2923281, for example, discloses a method of using a film using a chlorinated polyolefin resin as an adhesive layer to simultaneously perform resin molding and decorate a resin molded body (see examples).

Japanese Unexamined Patent Application Publication No. H09-156047 discloses a method of using a composite film using a polypropylene film as an adhesive layer (backing layer) to simultaneously perform resin molding and decorate a resin molded body (see examples).

Meanwhile, the polyolefins (such as polypropylene (PP)) preferably used as resins for resin molded bodies have low polarity due to lack of polar groups in their molecules, making it difficult to bond decorative films thereto using a simultaneous molding/decorating method or the like.

Polyethylene terephthalate (PET) is preferably used as the base material used in the decorative film from the perspectives of heat resistance and cost.

Referring to Japanese Patent No. 2923281 and Japanese Unexamined Patent Application Publication No. H09-156047, the inventors investigated adhesion with respect to a polyolefin molded body using a decorative film using PET as a base material and a chlorinated polyolefin resin or polypropylene film as an adhesive layer. As a result, it was discovered that laminates obtained using a simultaneous molding/decorating method or the like do not demonstrate the demanded levels of adhesion between the decorative film and the polyolefin molded body.

Thus, an object of the present technology is to provide a decorative film for a polyolefin molded body, the film having a PET base material, wherein the decorative film demonstrates superior adhesive properties with respect to polyolefin molded bodies, as well as a laminate in which the decorative film is laminated upon a polyolefin molded body.

### SUMMARY OF THE INVENTION

As the result of diligent research into resolving the problems described above, the inventors discovered that using a maleic acid-modified polypropylene in an adhesive layer improves adhesive properties with respect to polyolefin molded bodies, thereby arriving at the present technology. Specifically, the inventors discovered that the problems described above can be solved by the following features.

(1) A decorative film for a polyolefin molded body, the film comprising a PET base material (A) and an adhesive layer (B) containing a maleic acid-modified polypropylene.

(2) The decorative film for a polyolefin molded body according to (1), further comprising a primer layer (C) between the PET base material (A) and the adhesive layer (B).

(3) The decorative film for a polyolefin molded body according to (1) or (2), further comprising a decorative layer (D) between the PET base material (A) and the adhesive layer (B).

(4) The decorative film for a polyolefin molded body according to any of (1) to (3), wherein the adhesive layer (B) further contains a phenolic resin.

(5) The decorative film for a polyolefin molded body according to any of (2) to (4), wherein the primer layer (C) contains a phenolic resin and does not contain a maleic acid-modified polypropylene.

(6) The decorative film for a polyolefin molded body according to any of (2) to (5), wherein the primer layer (C) contains a phenolic resin and a phenoxy resin.

(7) The decorative film for a polyolefin molded body according to any of (3) to (6), further comprising a protective layer (E), for protecting the decorative layer (D), between the decorative layer (D) and the adhesive layer (B).

(8) A laminate in which the decorative film for a polyolefin molded body according to any of (1) to (7) is laminated to a polyolefin molded body.

As will be described below, the present technology provides a decorative film for a polyolefin molded body, the film having a PET base material, wherein the decorative film demonstrates superior adhesive properties with respect to polyolefin molded bodies, as well as a laminate in which the decorative film is laminated upon a polyolefin molded body.

### BRIEF DESCRIPTION OF THE DRAWINGS

FIG. 1 is a schematic cross-sectional view of an aspect of a decorative film for a polyolefin molded body according to the present technology.

FIG. 2 is a schematic cross-sectional view of an aspect of a first preferred embodiment of the decorative film for a polyolefin molded body according to the present technology.

FIG. 3 is a schematic cross-sectional view of an aspect of a second preferred embodiment of the decorative film for a polyolefin molded body according to the present technology.

FIG. 4 is a schematic cross-sectional view of an aspect of a third preferred embodiment of the decorative film for a polyolefin molded body according to the present technology.

FIG. 5 is a schematic cross-sectional view of an aspect of a fourth preferred embodiment of the decorative film for a polyolefin molded body according to the present technology.

### DETAILED DESCRIPTION OF THE INVENTION

The decorative film for a polyolefin molded body according to the present technology (hereafter, also referred to as the “decorative film according to the present technology”) comprises a PET base material (A) and an adhesive layer (B) containing a maleic acid-modified polypropylene.

The decorative film according to the present technology demonstrates superior adhesive properties with respect to polyolefin molded bodies by virtue of the features described above. The reasons therefor are presumed in general to be as follows.

Because polypropylene and polyethylene terephthalate (PET) have different molecular structures, they are different greatly in terms of resin polarity. Specifically, polyethylene terephthalate has a greater polarity than polypropylene. Therefore, when the attempt is made to laminate a decorative film comprising a base material of polyethylene terephthalate and an adhesive layer containing polypropylene or chlorinated polypropylene to a polyolefin molded body using a simultaneous molding/decorating method or the like, the vast difference in resin polarity between the base material and the adhesive layer leads to warping between the layers of the decorative film, impeding melt bonding between the melt-molded polyolefin molded body and the decorative film. It is presumed that, as a result, adhesive properties with respect to the polyolefin molded body is insufficient, as shown by comparative examples 1 and 2.

Meanwhile, the decorative film according to the present technology uses maleic acid-modified propylene in the adhesive layer, with the resultant interaction with the maleic acid (or maleic anhydride) yielding higher polarity compared to unmodified polypropylene or chlorinated polypropylene. As a result, the adhesive layer and the PET base material are comparatively closer in polarity, so that no warping occurs between the layers of the decorative film when it is laminated to the polyolefin molded body using a simultaneous molding/decorating method or the like, yielding conditions amenable to bonding with the decorative film layer. Moreover, the maleic acid-modified polypropylene demonstrates high compatibility with the polyolefin constituting the material of the adherend when softened, thereby exhibiting satisfactory functioning as an adhesive layer when creating a laminate via a simultaneous molding/decorating method or the like. It is presumed that, as a result, laminates obtained using the decorative film according to the present technology demonstrate superior adhesion.

A detailed description of the decorative film according to the present technology and the method of its manufacture will first be given below, followed by a detailed description of a laminate in which the decorative film according to the present technology is laminated to a polyolefin molded body.

### [Decorative Film]

The decorative film according to the present technology comprises a PET base material (A) and an adhesive layer (B) containing a maleic acid-modified polypropylene.

The PET base material (A) may be the outermost layer of the decorative film according to the present technology, and may be further provided with a topcoat layer, a hard coating layer (for example, a hard coating layer of urethane, acrylic, or urethane acrylic), or a protective film layer (for example, a polyester protective film) on a primary surface thereof on a side opposite the adhesive layer (B).

A primer layer (C), decorative layer (D), or protective layer (E) for protecting the decorative layer (D) may be optionally provided between the PET base material (A) and the adhesive layer (B). Another adhesive layer may also be provided between the PET base material (A) and the adhesive layer (B) as desired.

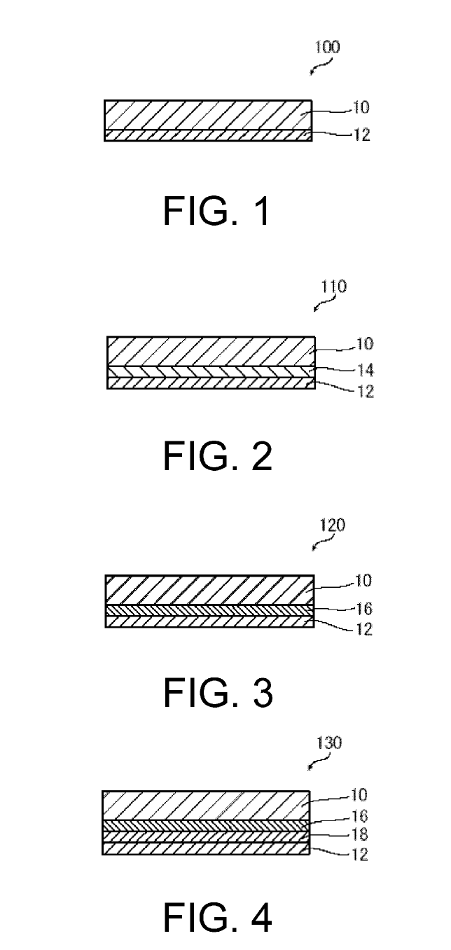

An aspect of the decorative film according to the present technology will be described with reference to the drawings. FIG. 1 is a schematic cross-sectional view of an aspect of a decorative film for a polyolefin molded body according to the present technology.

In FIG. 1, a decorative film 100 for a polyolefin molded body comprises a PET base material (A) 10 and an adhesive layer (B) 12.

First, the PET base material (A) and the adhesive layer (B) will be described in detail.

### <PET Base Material (A)>

The PET base material (A) used in the decorative film according to the present technology is not particularly limited as long as the PET base material (A) is formed from polyethylene terephthalate (PET).

Examples of the PET used for the PET base material (A) include drawn PET, undrawn PET, non-crystalline PET, crystalline PET, unmodified PET, and modified PET (for example, PET in which part of the terephthalic acid monomer is substituted by isophthalic acid), of which biaxially drawn PET is preferable due to its transparency and superior toughness, heat and cold resistance, and chemical resistance.

The PET base material (A) may contain a UV absorber from the perspective of weatherability.

The thickness of the PET base material (A) is preferably from 10 to 150 μm, more preferably from 15 to 100 μm, from the perspective of ease of handling.

Various surface treatments, such as corona discharge treatment, plasma discharge treatment, and alumina deposition treatment, may be performed on the PET base material (A).

### <Adhesive Layer (B)>

The adhesive layer (B) used in the decorative film according to the present technology is a layer containing a maleic acid-modified polypropylene.

As described above, the adhesive layer (B) functions as a layer for bonding with a polyolefin molded body when laminating the film to the polyolefin molded body.

An example of a preferred aspect for the adhesive layer (B) further contains a phenolic resin. Further including a phenolic resin within the adhesive layer (B) yields superior adhesive properties with respect to polyolefin molded bodies.

The maleic acid-modified polypropylene and phenolic resin used in the adhesive layer (B) will be described below.

### (Maleic Acid-Modified Polypropylene)

The maleic acid-modified polypropylene used in the adhesive layer (B) is not particularly limited as long as the maleic acid-modified polypropylene is a polypropylene modified using maleic acid and/or maleic anhydride.

Examples of the polypropylene used for the maleic acid-modified polypropylene include propylene homopolymer, propylene/ethylene bipolymer, propylene/butene bipolymer, propylene/ethylene/butene terpolymer, propylene/hexene/octene terpolymer, and the like, of which propylene homopolymer is preferable.

If the polypropylene is a copolymer, the proportion of propylene units is preferably at least 50%, more preferably at least 70%, and still more preferably at least 90%. In this context, “proportion of propylene units” refers to the proportion of propylene units with respect to the total number of polypropylene repeating units.

The polypropylene is preferably a chlorinated polypropylene, as such can be dissolved in a solvent and easily applied to a film. That is, the maleic acid-modified polypropylene used in the present technology is preferably a maleic acid-modified chlorinated polypropylene.

In order to obtain superior adhesive properties with respect to polyolefin molded bodies, the chlorinated polypropylene preferably has a chlorine content of from 5 to 30 mass %, more preferably from 10 to 25 mass %.

In order to obtain superior adhesive properties with respect to polyolefin molded bodies, the maleic acid-modified polypropylene preferably has a maleic acid modification rate of from 1 to 10 mass %, more preferably from 1 to 5 mass %.

The maleic acid-modified polypropylene is preferably obtained by graft copolymerizing maleic anhydride to polypropylene.

The maleic acid-modified polypropylene preferably has a weight average molecular weight of from 50,000 to 300,000, more preferably from 100,000 to 150,000.

Taking 100 mass % as the total mass of the adhesive layer (B), the maleic acid-modified polypropylene content is preferably at least 50 mass %, more preferably at least 80 mass %, and still more preferably at least 95 mass %.

### (Phenolic Resin)

Examples of the phenolic resin used in the adhesive layer (B) include a novolac phenolic resin and a resole phenolic resin, of which a resole phenolic resin is preferable due to its superior adhesive properties with respect to polyolefin molded bodies.

The phenolic resin used in the adhesive layer (B) preferably has a weight average molecular weight of from 150 to 1,200, more preferably from 500 to 1,000.

The phenolic resin content of the adhesive layer (B) is preferably from 0.1 to 20 mass %, more preferably from 1 to 10 mass % of the maleic acid-modified polypropylene content.

### (Additives)

Additives may be included in the adhesive layer (B) within the scope of the present technology. Examples of additives include fillers, antiaging agents, antioxidants, antistatic agents, flame retardants, dispersing agents, thixotropic agents, and the like.

There is no particular limitation upon the thickness of the adhesive layer (B), but a thickness of from 0.05 to 5 μm is preferable, a thickness of from 0.1 to 3 μm is more preferable, and a thickness of from 0.5 to 2 μm is still more preferable from the perspective of adhesive properties with respect to polyolefin molded bodies.

### <Manufacturing Method>

There is no particular limitation upon the method by which the decorative film according to the present technology is manufactured; any known method may be employed. One example is forming the adhesive layer (B) upon the PET base material (A).

Methods of forming the adhesive layer (B) upon the PET base material (A) include, for example, applying an adhesive layer-forming composition, described below, to the PET base material (A), or directly laminating an adhesive layer (B) film formed using the adhesive layer-forming composition onto the PET base material (A). Of these methods, the method of applying an adhesive layer-forming composition (application method) is preferred as it allows the thickness of the adhesive layer (B) to be easily controlled.

### (Adhesive Layer-Forming Composition)

The adhesive layer-forming composition contains the maleic acid-modified polypropylene. There is no particular limitation upon the maleic acid-modified polypropylene content of the adhesive layer-forming composition, but, from the perspective of ease of composition handling, per 100 mass % of the total composition, a content of from 1 to 20 mass % is preferable, and a content of from 5 to 15 mass % is more preferable.

The adhesive layer-forming composition preferably contains the phenolic resin. The phenolic resin content is preferably from 0.1 to 20 mass %, more preferably from 1 to 10 mass %, of the maleic acid-modified polypropylene content of the adhesive layer-forming composition.

The adhesive layer-forming composition may contain additives. Specific examples of additives include those given above.

The adhesive layer-forming composition may contain a solvent as necessary. Examples of solvents include water, alcohol-based solvents (for example, methanol, ethanol, propanol, ethylene glycol, glycerin, and propylene glycol monomethyl ether), ketone-based solvents (for example, acetone, methyl ethyl ketone, and cyclohexanone), amide-based solvents (for example, formamide, dimethyl acetamide, and N-methyl pyrrolidone), nitrile-based solvents (for example, acetonitrile and propionitrile), ester-based solvents (for example, methyl acetate, ethyl acetate, and propylene glycol monomethyl ether acetate), carbonate-based solvents (for example, dimethyl carbonate and diethyl carbonate), aliphatic hydrocarbon-based solvents (for example, hexane, cyclohexane, and methylcyclohexane), and aromatic hydrocarbon-based solvents (for example toluene and xylene). These solvents may be used singly or in mixtures.

There is no particular limitation upon the solvent content of the adhesive layer-forming composition, but, from the perspective of ease of composition handling, per 100 mass % of the total composition, a content of from 50 to 99 mass % is preferable, and a content of from 80 to 95 mass % is more preferable.

### (Application Method)

There is no particular limitation upon the method of application, with specific examples including application using a double roller coater, a slit coater, an air knife coater, a wire bar coater, a slide hopper, spray coating, a blade coater, a doctor coater, a squeeze coater, a reverse roller coater, a transfer roller coater, an extortion coater, a curtain coater, a dip coater, a die coater, or a gravure roller; extrusion coating methods; roller coating methods; and other known methods.

After application, heat drying may be performed as necessary to eliminate the solvent.

Optimal heat drying conditions may be selected, as appropriate, according to the solvent contained within the composition; in order to obtain a uniform decorative film, a heat drying temperature of from 100 to 150° C. is preferable, and a heat drying time of from 10 seconds to 1 minute.

### First Preferred Embodiment

A first preferred embodiment of the decorative film according to the present technology further comprises a primer layer (C) between the PET base material (A) and the adhesive layer (B). The provision of the primer layer (C) is preferable as it improves the adhesion between the layers of the decorative film, yielding superior adhesive properties with respect to polyolefin molded bodies.

An aspect of the first preferred embodiment of the decorative film according to the present technology will be described with reference to the drawings. FIG. 2 is a schematic cross-sectional view of an aspect of a first preferred embodiment of the decorative film for a polyolefin molded body according to the present technology. In FIG. 2, a decorative film 110 for a polyolefin molded body comprises a PET base material (A) 10, a primer layer (C) 14, and an adhesive layer (B) 12, in that order.

The PET base material (A) and adhesive layer (B) are as described above.

The primer layer (C) will be described in detail below.

### <Primer Layer (C)>

The primer layer (C) is a layer containing a thermosetting or thermoplastic resin, such as a phenolic resin, an epoxy resin, a urethane resin, or an acrylic resin, and, as described above, functions as a layer for improving the adhesion between the layers of the decorative film.

The primer layer (C) is preferably a layer containing a phenolic resin from the perspectives of superior adhesive properties with respect to the PET base material (A) and the adhesive layer (B), and preferably a layer containing a phenolic resin and a phenoxy resin from the perspective of improving the toughness of the obtained decorative film.

The primer layer (C) is preferably a layer that does not contain a maleic acid-modified polypropylene from the perspectives of superior adhesive properties with respect to the PET base material (A) and the adhesive layer (B).

The phenolic resin and the phenoxy resin used in the primer layer (C) will be described in detail below.

### (Phenolic Resin)

Examples of the phenolic resin used in the primer layer (C) include a novolac phenolic resin and a resole phenolic resin, of which a novolac phenolic resin is preferable due to its superior adhesive properties with respect to the PET base material.

The phenolic resin used in the primer layer (C) preferably has a weight average molecular weight of from 200 to 2,000, more preferably from 600 to 1,500.

The phenolic resin content of the primer layer (C) is preferably from 10 to 100 mass %, more preferably from 20 to 60 mass %, per 100 mass % of the total primer layer (C), from the perspective of blocking after application to the PET base material.

### (Phenoxy Resin)

The phenoxy resin used in the primer layer (C) is not limited as long as the phenoxy resin is a polyether resin synthesized from a diphenol such as bisphenol A and epichlorohydrin.

The phenoxy resin used in the primer layer (C) preferably has a weight average molecular weight of from 20,000 to 100,000, more preferably from 50,000 to 80,000.

The epoxy equivalent weight of the phenoxy resin is preferably from 3,000 to 10,000 g/eq, more preferably from 5,000 to 8,000 g/eq.

The phenoxy resin content of the primer layer (C) is preferably from 10 to 1,900 mass %, more preferably from 50 to 900 mass %, with respect to the phenolic resin content of the primer layer (C).

Additives may be included in the primer layer (C) within the scope of the present technology. Specific examples of additives are similar to those given for the adhesive layer (B) above.

There is no particular limitation upon the thickness of the primer layer (C), but, from the perspective of improving the toughness of the obtained decorative film, the thickness is preferably from 0.05 to 5 μm, more preferably from 0.1 to 3 μm, and still more preferably from 0.1 to 2 μm.

### <Manufacturing Method>

There is no particular limitation upon the method used to manufacture the decorative film according to the first preferred embodiment, and a known method may be employed. An example is to form the primer layer (C) upon the PET base material (A), then form the adhesive layer (B) upon the formed primer layer (C).

Methods of forming the primer layer (C) upon the PET base material (A) include, for example, applying a primer layer-forming composition, described below, to the PET base material (A), or directly laminating a primer layer (C) film formed using the primer layer-forming composition onto the PET base material (A). Of these methods, the method of applying a primer layer-forming composition (application method) is preferred as it allows the thickness of the primer layer (C) to be controlled.

Specific examples and preferred aspects of the method of forming the adhesive layer (B) upon the primer layer (C) are similar to the methods for forming the adhesive layer (B) upon the PET base material (A) described above.

### (Primer Layer-Forming Composition)

The primer layer-forming composition preferably contains the phenolic resin used in the primer layer (C). There is no particular limitation upon the phenolic resin content of the primer layer-forming composition, but, from the perspective of ease of composition handling, per 100 mass % of the total composition, a content of from 1 to 50 mass % is preferable, and a content of from 5 to 30 mass % is more preferable.

If the primer layer-forming composition contains a phenolic resin, the primer layer-forming composition preferably contains the phenoxy resin. The phenoxy resin content is preferably from 10 to 1,900 mass %, more preferably from 50 to 900 mass %, of the phenolic resin content of the primer layer-forming composition.

The primer layer-forming composition may contain additives. Specific examples of additives include those given above.

The primer layer-forming composition may contain a solvent as necessary. Specific examples of solvents include those given above.

The primer layer-forming composition preferably does not contain a maleic acid-modified polypropylene.

The method of applying the primer layer-forming composition is the same application method as for the adhesive layer-forming composition described above.

### Second Preferred Embodiment

A second preferred embodiment of the decorative film according to the present technology further comprises a decorative layer (D) between the PET base material (A) and the adhesive layer (B). Further providing a decorative layer (D) between the PET base material (A) and the adhesive layer (B) yields a decorative film capable of imparting the polyolefin molded body with a desired decorative effect.

An aspect of the second preferred embodiment of the decorative film according to the present technology will be described with reference to the drawings. FIG. 3 is a schematic cross-sectional view of an aspect of a second preferred embodiment of the decorative film for a polyolefin molded body according to the present technology. In FIG. 3, a decorative film 120 for a polyolefin molded body comprises a PET base material (A) 10, a decorative layer (D) 16, and an adhesive layer (B) 12, in that order.

The PET base material (A) and adhesive layer (B) are as described above.

The decorative layer (D) will be described in detail below.

### <Decorative Layer (D)>

Examples of the decorative layer (D) used in the decorative film according to the present technology include an ink layer, a metal layer, and the like.

Examples of pigments used in the ink layer include titanium white, carbon black, red iron oxide, chrome yellow, cobalt blue, and other inorganic pigments; aniline black, phthalocyanine blue, isoindolinone, quinacridone, and other organic pigments; powdered aluminum foil and other metal pigments; pearlescent (pearl) pigments; and the like.

Examples of binders used in the ink layer include polyester resin, urethane resin, acrylic resin, vinyl acetate resin, vinyl chloride-vinyl acetate copolymer, cellulose-based resin, and the like.

Examples of the metal in the metal layer include copper, nickel, chromium, titanium, cobalt, molybdenum, zirconium, tungsten, palladium, indium, tin, gold, silver, aluminum, and the like.

There is no particular limitation upon the thickness of the decorative layer (D), but the thickness is preferably from 15 to 75 nm, more preferably from 20 to 50 nm, if a metal layer (especially a vapor-deposited metal layer) is used, as this will yield superior adhesive properties with respect to polyolefin molded bodies.

### <Manufacturing Method>

There is no particular limitation upon the method used to manufacture the decorative film according to the second preferred embodiment, and a known method may be employed. An example is to form the decorative layer (D) upon the PET base material (A), then form the adhesive layer (B) upon the formed decorative layer (D).

If the decorative layer (D) is an ink layer, examples of methods of forming the decorative layer (D) on the PET base material (A) include known methods of printing using print inks (for example, gravure printing, screen printing, offset printing, and the like). In this context, “printing inks” refers to compositions containing a pigment, a binder, and a solvent. Specific examples of pigments, binders, and solvents include those given above.

If the decorative layer (D) is a metal layer, an example of the method used to form the decorative layer (D) on the PET base material (A) is vapor deposition of a metal upon the PET base material (A). Specific examples of metals include those given above. Examples of metal vapor deposition methods include sputtering, ion plating, and the like.

Specific examples and preferred aspects of the method of forming the adhesive layer (B) upon the decorative layer (D) are similar to the methods for forming the adhesive layer (B) upon the PET base material (A) described above.

### Third Preferred Embodiment

A third preferred embodiment of the decorative film according to the present technology further comprises a decorative layer (D) between the PET base material (A) and the adhesive layer (B), and further comprises a protective layer (E), for protecting the decorative layer (D), between the decorative layer (D) and the adhesive layer (B).

The provision of a protective layer (E) is preferable, as this will prevent damage to the decorative layer (D) during the process of manufacturing the decorative film.

An aspect of the third preferred embodiment of the decorative film according to the present technology will be described with reference to the drawings. FIG. 4 is a schematic cross-sectional view of an aspect of a third preferred embodiment of the decorative film for a polyolefin molded body according to the present technology. In FIG. 4, a decorative film 130 for a polyolefin molded body comprises a PET base material (A) 10, a decorative layer (D) 16, a protective layer (E) 18, and an adhesive layer 12 in this order.

The PET base material (A), adhesive layer (B), and decorative layer (D) are as described above.

The protective layer (E) will be described in detail below.

### <Protective Layer (E)>

As described above, the protective layer (E) functions to protect the decorative layer (D) (i.e., prevents damage to the decorative layer during the process of manufacturing the decorative film).

Examples of protective layers (E) include layers containing a polyester resin, a melamine resin, a urea resin, a urea-melamine resin, a urethane resin, an acrylic resin, a nitrocellulose resin, or the like. Of these, a layer containing a polyester resin is preferable.

There is no particular limitation upon the thickness of the protective layer (E), but, in order to improve the toughness of the obtained decorative film, the thickness is preferably from 0.1 to 10 μm, more preferably from 0.5 to 2.0 μm.

### <Manufacturing Method>

There is no particular limitation upon the method used to manufacture the decorative film according to the third preferred embodiment, and a known method may be employed. An example is to form the decorative layer (D) upon the PET base material (A), form the protective layer (E) upon the formed decorative layer (D), and form the adhesive layer (B) upon the formed protective layer (E).

Examples of the method used to form the protective layer (E) on the decorative layer (D) include applying a protective layer-forming composition, described hereafter, to the decorative layer (D), or directly laminating a protective layer (E) film formed using the protective layer-forming composition onto the decorative layer (D). Of these methods, the method of applying a protective layer-forming composition (application method) is preferred as it allows the thickness of the protective layer (E) to be controlled.

Specific examples and preferred aspects of the method used to form the decorative layer (D) upon the PET base material (A) are as described above.

Specific examples and preferred aspects of the method of forming the adhesive layer (B) upon the protective layer (E) are similar to the methods for forming the adhesive layer (B) upon the PET base material (A) described above.

### (Protective Layer-Forming Composition)

The protective layer-forming composition preferably contains a polyester resin. There is no particular limitation upon the polyester resin content of the protective layer-forming composition, but, from the perspective of ease of composition handling, per 100 mass % of the total composition, a content of from 1 to 40 mass % is preferable, and a content of from 10 to 30 mass % more preferable.

The protective layer-forming composition may contain a solvent as necessary. Specific examples of solvents include those given above.

The method of applying the protective layer-forming composition is the same application method as for the adhesive layer-forming composition described above.

### Fourth Preferred Embodiment

A fourth preferred embodiment of the decorative film according to the present technology further comprises a decorative layer (D) and a primer layer (C) between the PET base material (A) and the adhesive layer (B), and further comprises a protective layer (E), for protecting the decorative layer (D), between the decorative layer (D) and the adhesive layer (B).

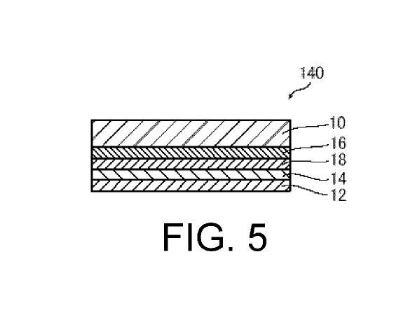

The fourth preferred embodiment of the decorative film according to the present technology will be described with reference to the drawings. FIG. 5 is a schematic cross-sectional view of a fourth preferred embodiment of the decorative film for a polyolefin molded body according to the present technology. In FIG. 5, a decorative film 140 for a polyolefin molded body comprises a PET base material (A) 10, a decorative layer (D) 16, a protective layer (E) 18, a primer layer (C) 14, and an adhesive layer 12, in that order.

The PET base material (A), adhesive layer (B), primer layer (C), decorative layer (D), and protective layer (E) are as described above.

### <Manufacturing Method>

There is no particular limitation upon the method used to manufacture the decorative film according to the fourth preferred embodiment, and a known method may be employed. An example is to form the decorative layer (D) upon the PET base material (A), form the protective layer (E) upon the formed decorative layer (D), form the primer layer (C) upon the protective layer (E), and form the adhesive layer (B) upon the primer layer (C).

Specific examples and preferred aspects of the method used to form the decorative layer (D) upon the PET base material (A), the method used to form the protective layer (E) on the decorative layer (D), and the method used to form the adhesive layer (B) upon the primer layer (C) are as described above.

Specific examples and preferred aspects of the method used to form the primer layer (C) upon the protective layer (E) are similar to the methods for forming the primer layer (C) upon the PET base material (A) described above.

### [Laminate]

The laminate according to the present technology is a laminate of the above described decorative film according to the present technology laminated upon a polyolefin molded body.

There is no particular limitation upon the method used to manufacture the laminate according to the present technology. Examples of methods used to manufacture the laminate according to the present technology include laminating the decorative film according to the present technology upon the polyolefin molded body via vacuum forming, pressure forming, or vacuum/pressure forming; preforming the decorative film according to the present technology via vacuum forming and/or pressure forming, followed by laminating the film via insert molding; and laminating using a simultaneous casting method (simultaneous molding/decorating method).

Specific examples of methods include those disclosed in Japanese Examined Patent Application Publication No. S56-045768, Japanese Examined Patent Application Publication No. S60-058014, Japanese Examined Patent Application Publication No. S50-019132, and Japanese Unexamined Patent Application Publication No. H11-091041.

The decorative film and laminate according to the present technology is useful for a variety of industrial parts, such as bumpers, instrument panels, trims, garnishes, and other automobile parts; television cases, washing machine tubs, refrigerator parts, air-conditioner parts, vacuum parts, and other parts for household electronics; toilet seats, toilet lids, cisterns, and other toilet-related parts; and parts for bathtubs, bathroom walls, and ceilings, drain pans, and other bathroom-related parts.

### EXAMPLES

The decorative film according to the present technology will be described in detail below with reference to examples. However, the present technology is not limited to these examples.

### (Preparation of Adhesive Layer-Forming Composition B1)

An adhesive layer-forming composition was prepared by stirring and mixing 14 parts by mass of SUPERCHLON® 892LS (Nippon Paper Chemicals Co., Ltd: maleic anhydride-modified chlorinated polypropylene; chlorine content: 22 mass %; weight average molecular weight: from 50,000 to 70,000), 0.5 parts by mass of Phenolite™ 5010 (DIC Corp.: resole phenolic resin; 50% ethanol solution), 60 parts by mass of methyl cyclohexane, and 26 parts by mass methyl ethyl ketone at room temperature. The prepared adhesive layer-forming composition was designated as adhesive layer-forming composition B1.

### (Preparation of Adhesive Layer-Forming Composition B2)

An adhesive layer-forming composition was prepared by stirring and mixing 14 parts by mass of SUPERCHLON® 892LS (Nippon Paper Chemicals Co., Ltd: maleic anhydride-modified chlorinated polypropylene; chlorine content: 22 mass %; weight average molecular weight: from 50,000 to 70,000), 60 parts by mass of methyl cyclohexane, and 26 parts by mass of methyl ethyl ketone at room temperature. The prepared adhesive layer-forming composition was designated as adhesive layer-forming composition B2.

### (Preparation of Adhesive Layer-Forming Composition X2)

An adhesive layer-forming composition was prepared by stirring and mixing 14 parts by mass of SUPERCHLON® 803 MWS (Nippon Paper Chemicals Co., Ltd: chlorinated polypropylene; chlorine content: 30 mass %; weight average molecular weight: approx. 150,000), 0.5 parts by mass of Phenolite™ 5010 (DIC Corp.: resole phenolic resin; 50% ethanol solution), 60 parts by mass of methyl cyclohexane, and 26 parts by mass of methyl ethyl ketone at room temperature. The prepared adhesive layer-forming composition was designated as adhesive layer-forming composition X2.

### (Preparation of Primer Layer-Forming Composition C1)

A primer layer-forming composition was prepared by stirring and mixing 10 parts by mass of Sumilite® resin PR-HF-3 (Sumitomo Bakelite Co., Ltd.: novolac phenolic resin; weight average molecular weight: 1,000), 10 parts by mass of jER1256 (Mitsubishi Chemical Corp.: phenoxy resin, bis-A type; epoxy equivalent weight: 8,000 g/eq; weight average molecular weight: 50,000), 56 parts by mass of methyl ethyl ketone, and 24 parts by mass of toluene at room temperature. The prepared adhesive layer-forming composition was designated as primer layer-forming composition C1.

### (Preparation of Primer Layer-Forming Composition C2)

A primer layer-forming composition was prepared by stirring and mixing 20 parts by mass of Sumilite® resin PR-HF-3 (Sumitomo Bakelite Co., Ltd.: novolac phenolic resin), 56 parts by mass of methyl ethyl ketone, and 24 parts by mass of toluene at room temperature. The prepared adhesive layer-forming composition was designated as primer layer-forming composition C2.

### (Preparation of Protective Layer-Forming Composition E1)

A protective layer-forming composition was prepared by stirring and mixing 100 parts by mass of DICDRY LX-75A (DIC Graphic: polyester coating agent) and 5 parts by mass of KW-40 (DIC Graphic: isocyanate) at room temperature. The prepared protective layer-forming composition was designated as protective layer-forming composition E1.

### Working Example 1

Chromium was vapor-deposited upon one primary surface of a PET base material (Teijin Ltd.: G2, thickness: 50 μm) by a sputtering method to form a metal layer (thickness: 50 nm).

The adhesive layer-forming composition B1 was applied over the formed metal layer using a gravure roller, then dried at 100° C. for one minute to form an adhesive layer (thickness: 1 μm) on the metal layer.

A decorative film comprising a PET base material, a metal layer, and an adhesive layer in that order was thus obtained. The obtained decorative film was designated as decorative film 1.

### Working Example 2

Chromium was vapor-deposited upon one primary surface of a PET base material (Teijin Ltd.: G2, thickness: 50 μm) by a sputtering method to form a metal layer (thickness: 50 nm).

The primer layer-forming composition C1 was applied over the formed metal layer using a gravure roller, then dried at 100° C. for one minute to form a primer layer (thickness: 1 μm) on the metal layer.

Next, the adhesive layer-forming composition B1 was applied over the formed primer layer using a gravure roller, then dried at 100° C. for one minute to form an adhesive layer (thickness: 1 μm) on the primer layer.

A decorative film comprising a PET base material, a metal layer, a primer layer, and an adhesive layer in that order was thus obtained. The obtained decorative film was designated as decorative film 2.

### Working Example 3

Chromium was vapor-deposited upon one primary surface of a PET base material (Teijin Ltd.: G2, thickness: 50 μm) by a sputtering method to form a metal layer (thickness: 50 nm).

The protective layer-forming composition E1 was applied over the formed metal layer using a gravure roller, then dried at 100° C. for one minute to form a protective layer (thickness: 1 μm) on the metal layer.

Next, the primer layer-forming composition C1 was applied over the formed protective layer using a gravure roller, then dried at 100° C. for one minute to form a primer layer (thickness: 1 μm) on the protective layer.

Next, the adhesive layer-forming composition B1 was applied over the formed primer layer using a gravure roller, then dried at 100° C. for one minute to form an adhesive layer (thickness: 1 μm) on the primer layer.

A decorative film comprising a PET base material, a metal layer, a protective layer, a primer layer, and an adhesive layer in that order was thus obtained. The obtained decorative film was designated as decorative film 3.

### Working Example 4

The primer layer-forming composition C1 was applied to one primary surface of a PET base material (Teijin Ltd.: G2; thickness: 50 μm) using a gravure roller, then dried at 100° C. for one minute to form a primer layer (thickness: 1 μm) upon the PET base material.

Next, the adhesive layer-forming composition B1 was applied over the formed primer layer using a gravure roller, then dried at 100° C. for one minute to form an adhesive layer (thickness: 1 μm) on the primer layer.

A decorative film comprising a PET base material, a primer layer, and an adhesive layer in that order was thus obtained. The obtained decorative film was designated as decorative film 4.

### Working Example 5

A decorative film was obtained according to a procedure similar to that used for working example 3, except that the adhesive layer-forming composition B2 was used instead of the adhesive layer-forming composition B1. The obtained decorative film was designated as decorative film 5.

### Working Example 6

A decorative film was obtained according to a procedure similar to that used for working example 3, except that the primer layer-forming composition C2 was used instead of the primer layer-forming composition C1. The obtained decorative film was designated as decorative film 6.

### Comparative Example 1

Chromium was vapor-deposited upon one primary surface of a PET base material (Teijin Ltd.: G2, thickness: 50 μm) by a sputtering method to form a metal layer (thickness: 50 nm).

The protective layer-forming composition E1 was applied over the formed metal layer using a gravure roller, then dried at 100° C. for one minute to form a protective layer (thickness: 1 μm) on the metal layer.

Next, a polypropylene film (thickness: 150 μm) was attached onto the formed protective layer as an adhesive layer (backing layer).

A decorative film comprising a PET base material, a metal layer, a protective layer, and an adhesive layer in that order was thus obtained. The obtained decorative film was designated as decorative film X1.

### Comparative Example 2

A decorative film was obtained according to a procedure similar to that used for working example 3, except that the adhesive layer-forming composition X2 was used instead of the adhesive layer-forming composition B1. The obtained decorative film was designated as decorative film X2.

### <Manufacturing a Laminate>

The obtained decorative film was placed in a die. Then, TPO resin (Mitsui Chemicals, Inc.: Milastomer™; hardness: JIS A80 (per JIS K 6253)) hot-melted to 190° C. was injected and subsequently cooled to obtain a laminate (thickness: 3 mm; width: 25 mm; length: 100 mm) formed using the decorative film.

### <Adhesion>

10 mm of the decorative film was peeled from one end of the obtained molded body. Using a tensile tester, the end of the peeled decorative film was grasped, and the 90° peel strength (N/25 mm width) was measured (pulling speed: 50 mm). The measured peel strengths are shown in table 1.

In table 1, the layers comprised by the working examples and comparative examples are indicated by “ ”.

TABLE 1
Table 1

| | | Working | Working | Working | Working | Working | Working | Comparative | Comparative |
|---|---|---|---|---|---|---|---|---|---|
| | | Example 1 | Example 2 | Example 3 | Example 4 | Example 5 | Example 6 | Example 1 | Example 2 |
| Decorative film | | Decorative | Decorative | Decorative | Decorative | Decorative | Decorative | Decorative | Decorative |
| | | film 1 | film 2 | film 3 | film 4 | film 5 | film 6 | film X1 | film X2 |
| PET base | PET base material | | | | | | | | |
| material | | | | | | | | | |
| Decorative | Metal layer | | | | | | | | |
| layer | (chromium) | | | | | | | | |
| Protective | Protective layer- | | | | | | | | |
| layer | forming composition | | | | | | | | |
| | E1 | | | | | | | | |
| Primer | Primer layer- | | | | | | | | |
| layer | forming composition | | | | | | | | |
| | C1 (Phenolic resin + | | | | | | | | |
| | phenoxy resin) | | | | | | | | |
| | Primer layer- | | | | | | | | |
| | forming composition | | | | | | | | |
| | C2 (Phenolic resin) | | | | | | | | |
| Adhesive | Adhesive layer- | | | | | | | | |
| layer | forming composition | | | | | | | | |
| | B1 (maleic | | | | | | | | |
| | anhydride-modified | | | | | | | | |
| | chlorinated PP + | | | | | | | | |
| | phenolic resin) | | | | | | | | |
| | Adhesive layer- | | | | | | | | |
| | forming composition | | | | | | | | |
| | B2 (maleic | | | | | | | | |
| | anhydride-modified | | | | | | | | |
| | chlorinated PP) | | | | | | | | |
| | Adhesive layer film | | | | | | | | |
| | X1 (PP film) | | | | | | | | |
| | Adhesive layer- | | | | | | | | |
| | forming composition | | | | | | | | |
| | X2 (chlorinated PP) | | | | | | | | |

| | | | | | | | | |
|---|---|---|---|---|---|---|---|---|
| Peel strength [N/25 mm width] | 187 | 208 | 215 | 211 | 190 | 180 | 30 | 40 |
| Film mass [g/m²] | 140 | 140 | 140 | 140 | 140 | 140 | 300 | 140 |

As can be seen from Table 1, all of the working examples of the present application, the adhesive layers of which contain maleic acid-modified polypropylene, exhibited superior adhesion compared to comparative examples 1 and 2, the adhesive layers of which do not contain maleic acid-modified polypropylene.

A comparison of working examples 1 to 3 shows that working examples 2 and 3, which further comprise primer layers (C), exhibited more superior adhesion. Of these, working example 3, which further comprises a protective layer (E), exhibited even more superior adhesion.

A comparison of working examples 3 and 5 shows that working example 3, the adhesive layer (B) of which further contains a phenolic resin, exhibited more superior adhesion.

A comparison of working examples 3 and 6 shows that working example 3, the primer layer (C) of which contains a phenoxy resin, exhibited more superior adhesion than working example 6, the primer layer (C) of which does not contain a phenoxy resin.

What is claimed is:

1. A decorative film for a polyolefin molded body, the film comprising:
a PET base material (A); and
an adhesive layer (B); wherein
the adhesive layer (B) contains a maleic acid-modified polypropylene.

2. The decorative film for a polyolefin molded body according to claim 1, further comprising a primer layer (C) between the PET base material (A) and the adhesive layer (B).

3. The decorative film for a polyolefin molded body according to claim 1, further comprising a decorative layer (D) between the PET base material (A) and the adhesive layer (B).

4. The decorative film for a polyolefin molded body according to claim 1, wherein the adhesive layer (B) further contains a phenolic resin.

5. The decorative film for a polyolefin molded body according to claim 2, wherein the primer layer (C) contains a phenolic resin and does not contain a maleic acid-modified polypropylene.

6. The decorative film for a polyolefin molded body according to claim 2, wherein the primer layer (C) contains a phenolic resin and a phenoxy resin.

7. The decorative film for a polyolefin molded body according to claim 3, further comprising a protective layer (E), for protecting the decorative layer (D), between the decorative layer (D) and the adhesive layer (B).

8. A laminate in which the decorative film for a polyolefin molded body described in claim 1 is laminated to a polyolefin molded body.

9. The decorative film for a polyolefin molded body according to claim 2, further comprising a decorative layer (D) between the PET base material (A) and the adhesive layer (B).

10. The decorative film for a polyolefin molded body according to claim 2, wherein the adhesive layer (B) further contains a phenolic resin.

11. A laminate in which the decorative film for a polyolefin molded body described in claim 2 is laminated to a polyolefin molded body.

12. The decorative film for a polyolefin molded body according to claim 3, wherein the adhesive layer (B) further contains a phenolic resin.

13. The decorative film for a polyolefin molded body according to claim 3, wherein the primer layer (C) contains a phenolic resin and does not contain a maleic acid-modified polypropylene.

14. The decorative film for a polyolefin molded body according to claim 3, wherein the primer layer (C) contains a phenolic resin and a phenoxy resin.

15. A laminate in which the decorative film for a polyolefin molded body described in claim 3 is laminated to a polyolefin molded body.

16. The decorative film for a polyolefin molded body according to claim 4, wherein the primer layer (C) contains a phenolic resin and does not contain a maleic acid-modified polypropylene.

17. The decorative film for a polyolefin molded body according to claim 4, wherein the primer layer (C) contains a phenolic resin and a phenoxy resin.

18. The decorative film for a polyolefin molded body according to claim 4, further comprising a protective layer (E), for protecting the decorative layer (D), between the decorative layer (D) and the adhesive layer (B).

19. A laminate in which the decorative film for a polyolefin molded body described in claim 4 is laminated to a polyolefin molded body.

20. The decorative film for a polyolefin molded body according to claim 5, wherein the primer layer (C) contains a phenolic resin and a phenoxy resin.
